(19) United States
(12) Patent Application Publication
(10) Pub. No.: US 2026/0039447 A1
(43) Pub. Date: Feb. 5, 2026

(54) FRAME STRUCTURE CONFIGURATION

(71) Applicant: Nokia Technologies Oy, Espoo (FI)

(72) Inventors: Guillermo POCOVI, Aalborg (DK); Claudio ROSA, Aalborg (DK); Nhat-Quang NHAN, Massy (FR); Jing Yuan SUN, Beijing (CN); Karri Markus RANTA-AHO, Espoo (FI)

(21) Appl. No.: 19/099,401

(22) PCT Filed: Aug. 5, 2022
(86) PCT No.: PCT/CN2022/110630

§ 371 Date: Jan. 28, 2025

(51) Int. Cl. H04L 5/14; H04W 72/0446; H04W 72/0453; H04W 72/1268; H04W 72/231

(52) U.S. Cl. CPC H04L 5/14; H04W 72/0446; H04W 72/0453; H04W 72/1268; H04W 72/231

(57) ABSTRACT

Embodiments of the present disclosure relate to devices, methods, apparatuses and computer readable storage media of resource allocation for time-division or frequency-division duplexing communication. The method comprising: receiving, at a first device and from a second device, first configuration information indicating a set of resources for time-division or frequency-division duplexing communication between the first device and the second device, the set of resources comprising a first subset of the resources for uplink transmission; and receiving, from the second device, second configuration information indicating at least one second subset of the resources for the uplink transmission, the at least one second subset of the resources comprising at least one resource other than the first subset of the resources.

### FIELD

Embodiments of the present disclosure generally relate to the field of telecommunication and in particular, to devices, methods, apparatus and computer readable storage media for enhancements on frame structure configurations.

### BACKGROUND

In a communication system, there are mainly two duplexing modes used for uplink (UL) and downlink (DL) transmissions, i.e., Frequency Division Duplexing (FDD) and Time Division Duplexing (TDD). In FDD, paired bands are used for simultaneous DL and UL transmissions, and there is a guard band in between. In TDD, unpaired bands are used, and resources are split in time domain to be different symbols or slots for DL and UL transmissions, respectively. Allocation of a time duration for UL in TDD would result in a reduced coverage and capacity as well as an increased latency.

Motivated by this, the evolution of duplexing operations in 5G New Radio (NR) has been proposed to allow simultaneous DL and UL transmissions on different physical resource blocks (PRBs) within an unpaired band of a cell.

### SUMMARY

In general, example embodiments of the present disclosure provide a solution of frame structure configuration.

In a first aspect, there is provided a first device. The first device comprises at least one processor; and at least one memory storing instructions that, when executed by the at least one processor, cause the first device at least to: receive, from a second device, first configuration information indicating a set of resources for time-division or frequency-division duplexing communication between the first device and the second device, the set of resources comprising a first subset of the resources for uplink transmission; and receive, from the second device, second configuration information indicating at least one second subset of the resources for the uplink transmission, the at least one second subset of the resources comprising at least one resource other than the first subset of the resources.

In a second aspect, there is provided a second device. The second device comprises at least one processor; and at least one memory storing instructions that, when executed by the at least one processor, cause the second device at least to: transmit, to a first device, first configuration information indicating a set of resources for time-division or frequency division duplexing communication between the first device and the second device, the set of resources comprising a first subset of the resources for uplink transmission; and transmit, to the first device, second configuration information indicating at least one second subset of the resources for the uplink transmission, the at least one second subset of the resources comprising at least one resource other than the first subset of the resources.

In a third aspect, there is provided a method. The method comprises: receiving, at a first device and from a second device, first configuration information indicating a set of resources for time-division or frequency-division duplexing communication between the first device and the second device, the set of resources comprising a first subset of the resources for uplink transmission; and receiving, from the second device, second configuration information indicating at least one second subset of the resources for the uplink transmission, the at least one second subset of the resources comprising at least one resource other than the first subset of the resource.

In a fourth aspect, there is provided a method. The method comprises: transmitting, at a second device and to a first device, first configuration information indicating a set of resources for time-division or frequency division duplexing communication between the first device and the second device, the set of resources comprising a first subset of the resources for uplink transmission; and transmitting, to the first device, second configuration information indicating at least one second subset of the resources for the uplink transmission, the at least one second subset of the resources comprising at least one resource other than the first subset of the resources.

In a fifth aspect, there is provided a first apparatus. The first apparatus comprises: means for receiving, from a second apparatus, first configuration information indicating a set of resources for time-division or frequency-division duplexing communication between the first apparatus and the second apparatus, the set of resources comprising a first subset of the resources for uplink transmission; and means for receiving, from the second apparatus, second configuration information indicating at least one second subset of the resources for the uplink transmission, the at least one second subset of the resources comprising at least one resource other than the first subset of the resources.

In a sixth aspect, there is provided a second apparatus. The second apparatus comprises: means for transmitting, to a first apparatus, first configuration information indicating a set of resources for time-division or frequency division duplexing communication between the first apparatus and the second apparatus, the set of resources comprising a first subset of the resources for uplink transmission; and means for transmitting, to the first apparatus, second configuration information indicating at least one second subset of the resources for the uplink transmission, the at least one second subset of the resources comprising at least one resource other than the first subset of the resources.

In a seventh aspect, there is provided a computer readable medium having a computer program stored thereon which, when executed by at least one processor of a device, causes the device to carry out the method according to the third aspect.

In an eighth aspect, there is provided a computer readable medium having a computer program stored thereon which, when executed by at least one processor of a device, causes the device to carry out the method according to the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example network system in which example embodiments of the present disclosure can be implemented;

FIG. 2A and FIG. 2B illustrate example configurations of TDD pattern suitable for the example embodiments of the present disclosure;

FIG. 3 shows a signaling chart illustrating an example procedure for frequency-time resource configuration according to some example embodiments of the present disclosure;

FIG. 4A illustrates a schematic diagram of an example configuration of UL subbands according to some example embodiments of the present disclosure;

FIG. 4B illustrates a schematic diagram of an example configuration of UL subbands according to some example embodiments of the present disclosure;

FIG. 4C illustrates a schematic diagram of an example configuration of UL subbands according to some example embodiments of the present disclosure;

FIG. 5A illustrates a schematic diagram of an example configuration of UL subbands according to some example embodiments of the present disclosure;

FIG. 5B illustrates a schematic diagram of another example configuration of UL subbands according to some example embodiments of the present disclosure;

FIG. 6A illustrates a schematic diagram of an example assignment of UL subbands to TDD-UL-DL pattern according to some example embodiments of the present disclosure;

FIG. 6B illustrates a schematic diagram of an example configuration of dynamic activation or deactivation of UL subbands according to some example embodiments of the present disclosure;

FIG. 7 illustrates a flowchart of an example method according to some example embodiments of the present disclosure;

FIG. 8 illustrates a flowchart of another example method according to some example embodiments of the present disclosure;

FIG. 9 shows a simplified block diagram of a device that is suitable for implementing example embodiments of the present disclosure; and

FIG. 10 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, “at least one of the following: <a list of two or more elements> and “at least one of <a list of two or more elements> and similar wording, where the list of two or more elements are joined by “and” or “or”, means at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a Next Generation NodeB (NR NB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT).

The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

In order to allow simultaneous DL and UL transmissions on PRBs within an unpaired wideband of a NR cell, a combination of TDD and FDD is proposed, which may be referred to as subband non-overlapping full duplexing (SBFD) scheme. In SBFD, at least part of resources configured for DL transmission in time domain may be dynamically or semi-statistically assigned to UL transmission. In other words, a SBFD frame is in a form of UL-DL PRB split.

To implement the SBFD frame, several challenges are faced. First, the location and size of such UL-DL subbands may not be fixed, thus the UE needs to be aware of time and frequency locations of subbands to be used for SBFD operation with the gNB. Therefore, a signaling of SBFD frame configuration is needed.

Backward compatibility with the gNB or UE that support only a normal TDD or FDD operation need to be ensured. The gNBs or corresponding cells that support the SBFD operation are expected to coexist with other gNBs or cells that support only normal TDD operation from both cochannel (i.e., cells deployed on the same carrier frequency, e.g., belonging to the same operator) and adjacent channel perspective (i.e., cells deployed on an adjacent carrier frequency, e.g., belonging to a different operator). In addition, existing 5G UEs, which cannot be upgraded to support SBFD-specific functionalities, may be served on SBFD-capable cells without experiencing performance degradation, e.g., as compared to the performance in normal TDD cells.

In order to solve the above and other potential problems, embodiments of the present disclosure provide a solution of SBFD frame structure and related configurations. The configuration of the UL-DL PRB split is flexible, i.e., the location and size of UL-DL resources or subbands may be configured, e.g., at a cell level or at an operator level, or may even change over time in each individual cell. To this end, one or more signaling is enabled by the gNB for configurating the UL-DL PRB split, for example, by configurating, activating or deactivating one or more UL subbands. In addition, non-symmetrical SBFD subframe configurations by assigning TDD pattern 1 and pattern 2 with different subband configurations are possible. In some example embodiments of the present disclosure, the terms “UL-DL PRB split” and “UL subband” may be used interchangeably.

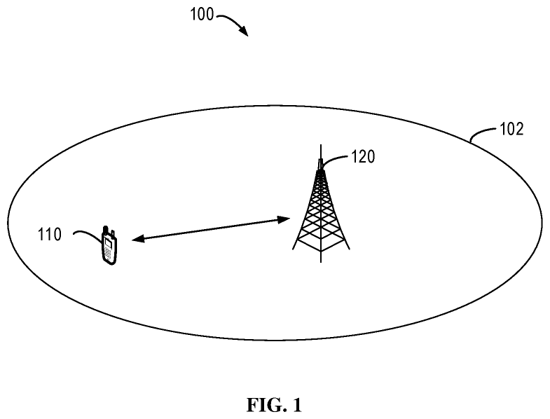

FIG. 1 illustrates an example network system 100 in which example embodiments of the present disclosure can be implemented. As shown in FIG. 1, the communication network 100 may include a first device 110 and a second device 120. The first device 110 may be a terminal device (e.g., UE). The second device 120 may be a network device (e.g., gNB) serving terminal devices, e.g., the first device 110 located in the cell 102. Hereinafter, the first device 110 may be also referred to as the UE 110, and the second device 120 may be also referred to as the gNB 120.

The first device 110 and the second device 120 may communicate with each other based on a normal FDD scheme, a normal TDD scheme, or a SBFD scheme. In the context of the present disclosure, SBFD scheme may be referred to as cross-division duplexing (xDD) scheme, flexible duplexing (FDU) scheme and so on. A link from the first device 110 to the second device 120 is referred to as UL, while a link from the second device 120 to the first device 110 is referred to as DL.

In TDD, the second device 120 may indicate a configuration of TDD-UL-DL-Pattern to the first device 110. In particular, the second device 10 may configure or indicate a unit time resource (e.g., a symbol or a slot) as “DL” or “UL” or “flexible” via a RRC configuration. There is a common pattern that is broadcast as part of system information in TDD-UL-DL-ConfigCommon, and accordingly received by all the UEs in the cell 102.

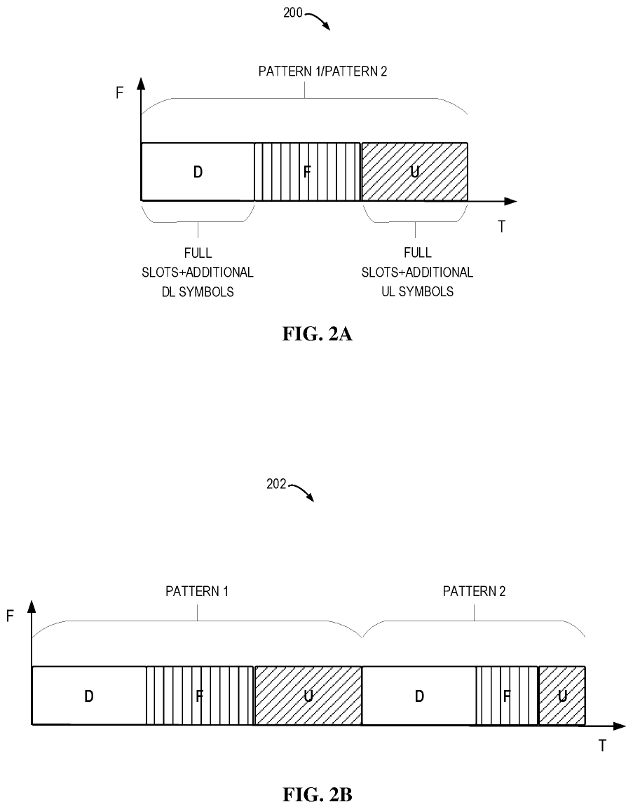

FIG. 2A and FIG. 2B illustrate example configurations of the TDD pattern suitable for the embodiments of the present disclosure. As shown in FIG. 2A, the TDD-UL-DL-Pattern 200 is configured via TDD-UL-DL-ConfigCommon, which may be either pattern 1 or pattern 2. As shown in FIG. 2B, the TDD-UL-DL-Pattern 202 is configured via TDD-UL-DL-ConfigCommon, which may be two concatenated patterns, i.e., both the pattern 1 and pattern repeated in time domain. The PRBs of a symbol have the same characterization of “D” for DL, “F” for flexible, or “U” for UL. The configured patterns include a DL phase in the beginning and an UL phase in the end, and what is left in between is designated as “flexible”. The flexible symbols are meant to be usable opportunistically for either UL or DL, which may be subject to the gNB decision, either
dynamically scheduling the UE to transmit UL transmissions or receive DL transmissions with a scheduling downlink control information (DCI), e.g., DCI format 0_x for UL, DCI formats 1_x for DL, where x denotes 0, 1 or 2,
semi-statically providing additional UE-dedicated configuration signaling over radio resource control (RRC) in TDD-UL-DL-ConfigDedicated that further designates part of or all the flexible symbols of the TDD-UL-DL-ConfigCommon as DL or as UL,
transmitting a DCI format 2_0 (i.e., an SFI) that further designates the “flexible” symbols left after the common and dedicated RRC configurations either as DL or as UL.

In some example embodiments, the second device 120 may indicate UL-DL split or subband configuration to the first device 110. This allows converting some of the resources originally assigned as DL or flexible to be UL. In the context of the present disclosure, the UL-DL split refers to at least a set of UL resources or subbands (e.g., REs, PRBs) that converts from a set of DL and Flexible symbols to include a set of resource elements that can be used for UL transmission. In SBFD scheme, an SBFD UL subband is created on DL (and possibly flexible) symbols within a full carrier or BWP bandwidth. In this way, dynamically adjustment of subband configuration is supported, e.g., in line with traffic demands.

It should be understood that in the following, the embodiments may be described in conjunction with TDD scheme, however, the SBFD frame configuration and the UL-DL split provided in the present disclosure are also applicable for FDD scheme. Therefore, the present disclosure is not limited in this regard.

It should be also understood that the number of the network device and the terminal device shown in FIG. 1 is given for the purpose of illustration without suggesting any limitations. The communication network 100 may include any suitable number of network devices and terminal devices.

Depending on the communication technologies, the communication network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

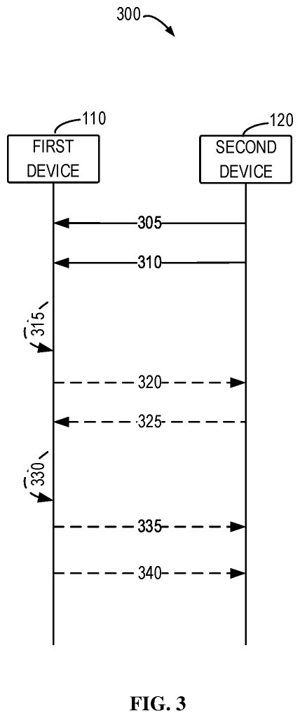

Principle and implementations of the present disclosure will be described in detail below with reference to FIGS. 3 to 8. FIG. 3 shows a signaling chart illustrating an example process 300 for frequency-time resource configuration according to some example embodiments of the present disclosure. The process 300 may involve the first device 110 and the second device 120 as shown in FIG. 1. For discussion, the process 300 will be described with reference to FIG. 1.

By way of example, the process 300 may be implemented in a scenario where the first device 110 and the second device 120 communicate in FDD or TDD mode. In the process 300, the second device 120 transmits 305 first configuration information indicating a set of resources for TDD or FDD communication between the first device 110 and the second device 120. The set of resources may include a first subset of the resources for uplink transmission.

For example, the first configuration information may be a TDD-UL-DL-Pattern indicated via TDD-UL-DL-ConfigCommon. The TDD-UL-DL-ConfigCommon may be contained in a RRC system information broadcast (SIB). In case of TDD, a set of resources may be symbols or slots for DL and UL transmissions assigned in the TDD-UL-DL-Pattern, and the first subset of the resources may be the UL symbols or slots.

In some cases, in addition to TDD-UL-DL-ConfigCommon, the second device 120 may transmit TDD-UL-DL-ConfigDedicated, e.g., DDDDU, to maintain backwards compatibility.

The second device 120 transmits 310 second configuration information indicating at least one second subset of the resources for the uplink transmission. In this case, the at least one second subset of the resources is configured as UL-DL split and includes at least one resource other than the first subset of the resources. The second configuration information may be contained, for example, in a SIB, a RRC message or so on.

In the context of the present disclosure, the first subset of the resources may refer to at least one UL slot or symbols in one or more TDD-UL-DL pattern. The second subset of the resources may refer to one or more subband assigned for UL transmissions in at least one DL (or flexible) slot or symbols in one or more TDD-UL-DL pattern By way of example, a total of 4 subbands, e.g., SBFD_UL_subband1, . . . , SBFD_UL_subband4 may be configured, where SBFD_UL_subband1 is assigned to TDD pattern 1, and SBFD_UL_subband1 and SBFD_UL_subband3 are assigned to TDD pattern 2, i.e. the same subband can be assigned to one or more TDD patterns and not all subbands need to be assigned to the one or more TDD patterns.

In some example embodiments, the first subset of the resources may not overlap with the at least one second subset of the resources. Alternatively, in some other embodiments, at least a part of the first subset of the resources may overlap with the at least one second subset of the resources. Thus, the scope of the present disclosure is not limited in this regard.

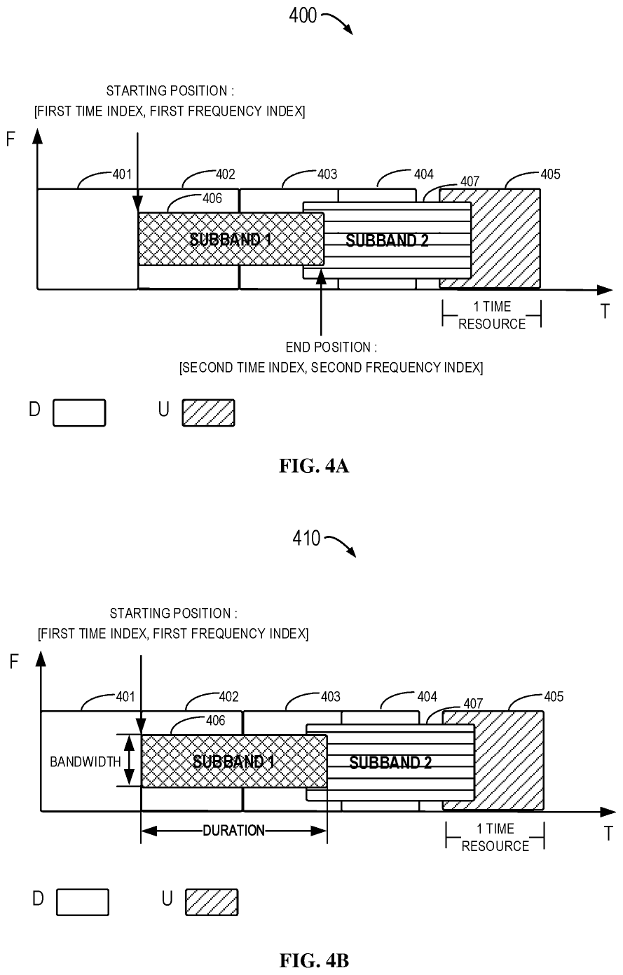

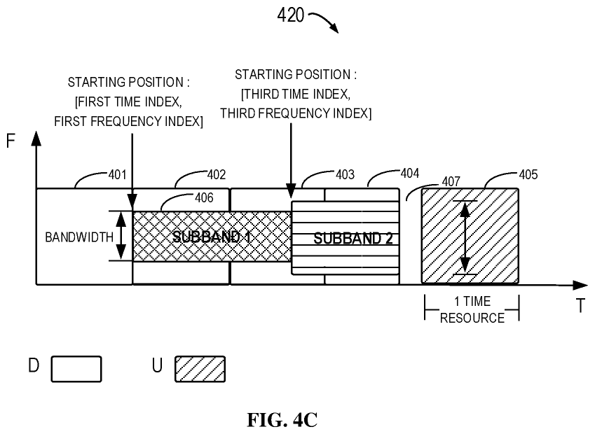

Now reference is made to FIG. 4A to FIG. 4C to describe SBFD resource configurations according to the embodiments of present disclosure. It should be understood that a resource unit in time domain and frequency domain is given for the purpose of illustration without suggesting the classifying approaches of the classification model of the first type. In the examples shown in FIG. 4A to FIG. 4E, the unit of time resources may be a symbol or a slot, while the unit of frequency resources may be a subcarrier, however, any other resource unit or resolution may be also suitable for implementations of the SBFD resource configuration.

In some example embodiments, the second configuration information may include:
a first indication of a starting frequency resource and a starting time resource of one of the at least one second subset of the resources, and
a second indication of an end frequency resource and an end time resource of the second subset of the resources.

To this end, the second configuration information may be in a form of two tuples [symbol, PRB] for indicating respectively the starting and end positions of each of the UL subbands. FIG. 4A illustrates a schematic diagram of an example configuration 400 of UL subbands according to some example embodiments of the present disclosure. As indicated by first configuration indication, slots 401 to 404 are assigned for DL transmissions, while slot 405 is assigned for UL transmission. The second configuration indication may indicate UL-DL split 406 and 407 corresponding to subband 1 and subband 2 for UL transmissions, which are shown as RE/symbol rectangles.

A location and size of each of the UL-DL splits 406 and 407 can be determined based on starting and ending points of a corresponding subband in both time and frequency domains, i.e., the two opposite vertices of the RE/symbol rectangle. Accordingly, the starting and end positions of UL subband 1 may be indicated by [first time index, first frequency index] and [second time index, second frequency index], respectively. The starting and end positions of UL subband 2 may be indicated in a similar manner.

In some example embodiments, the second configuration information may include a starting frequency resource and a starting time resource of one of the at least one second subset of the resources, a first number of frequency resources in the second subset, and a second number of time resources in the second subset. FIG. 4B illustrates a schematic diagram of an example configuration 410 of UL subbands according to some example embodiments of the present disclosure. Like the configuration 400, slots 401 to 404 are assigned for DL transmissions, while slot 405 is assigned for UL transmission, as indicated by the first configuration information. The second configuration indication indicates UL-DL split 406 and 407 corresponding to subband 1 and subband 2 for UL transmissions, which are shown as RE/symbol rectangles.

The location and size of each of the UL-DL splits 406 and 407 can be determined based on a starting point of a corresponding subband in both time and frequency domains as well as a bandwidth and time duration of the subband. Accordingly, the starting position of UL subband 1 may be indicated by [first time index, first frequency index]. The bandwidth may be indicted by the number of frequency resources (e.g., PRBs) in frequency domain, and the time duration may be indicated by the number of time resources (e.g., symbols, slots, etc.) in time domain.

In some example embodiments, the at least one second subset of the resources may comprise a first target subset of the resources and a second target subset of the resources. In these embodiments, the second configuration information may include:
a third indication of a starting frequency resource and a starting time resource of the first target subset of the resources, and a first bandwidth of a first uplink sub-band corresponding to the first target subset of the resources, and
a fourth indication of a starting frequency resource and a starting time resource of the second target subset of the resources, and a second bandwidth of a second uplink sub-band corresponding to the second target subset of the resources.

In the above case, the starting time resource of the second target subset of the resources may by the first symbol after an end time resource of the first target subset of the resources in time domain. FIG. 4C illustrates a schematic diagram of an example configuration 420 of UL subbands according to some example embodiments of the present disclosure. Like configurations 400 and 410, slots 401 to 404 are assigned for DL transmissions, while slot 405 is assigned for UL transmission, as indicated by the first configuration information. The second configuration indication indicates UL-DL split 406 and 407 corresponding to subband 1 and subband 2 for UL transmissions.

As shown in FIG. 4C, each of the subbands 1 and 2 is indicated with a starting PRB and a starting symbol and a bandwidth. The starting PRB and a starting symbol may be indicated by [first time index, first frequency index]. With the starting PRB and the bandwidth, the frequency domain allocation of each subband can be determined. For the time domain allocation, it is assumed that the last symbol of the last subband (i.e., the subband 2) is fixed in time domain, for example, which may be specified as the last DL symbol in the S slot, or the last symbol of the S slot, etc. Accordingly, the last symbol of any other subband (i.e., the subband 1) is the starting symbol of the next subband (i.e., the subband 2). In this way, the time domain allocation of each subband can be derived based on the configured starting symbol of each subband.

In some example embodiments, the second configuration information may include:
a first resource indicator value (RIV) that indicates a starting frequency resource and a number of frequency resources in one of the at least one second subset of the resources; and
a second RIV that indicates a starting time resource and a duration of time resources in the second subset of resources.

In the above embodiments, the frequency-time square corresponding to the UL-DL split is indicated in a similar way of providing the physical uplink shared channel (PUSCH) resource allocation. A RIV provides jointly a starting PRB and a number of PRBs within the active bandwidth part (BWP) or within the common RB (CRB) grid. Furthermore, a corresponding Start and Length Indicator Value (SLIV) provides jointly the starting position and the time duration within the TDD-UL-DL-Pattern.

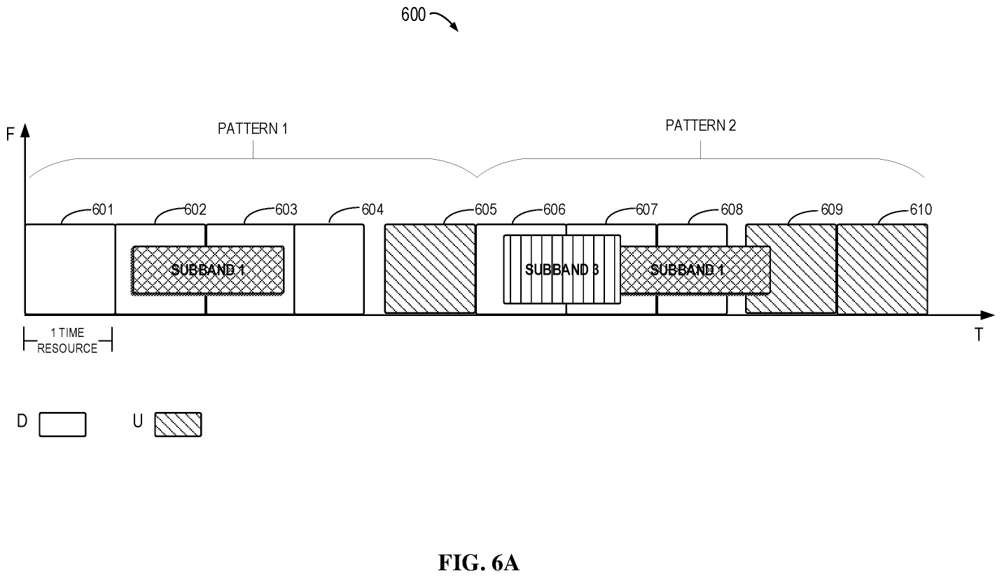

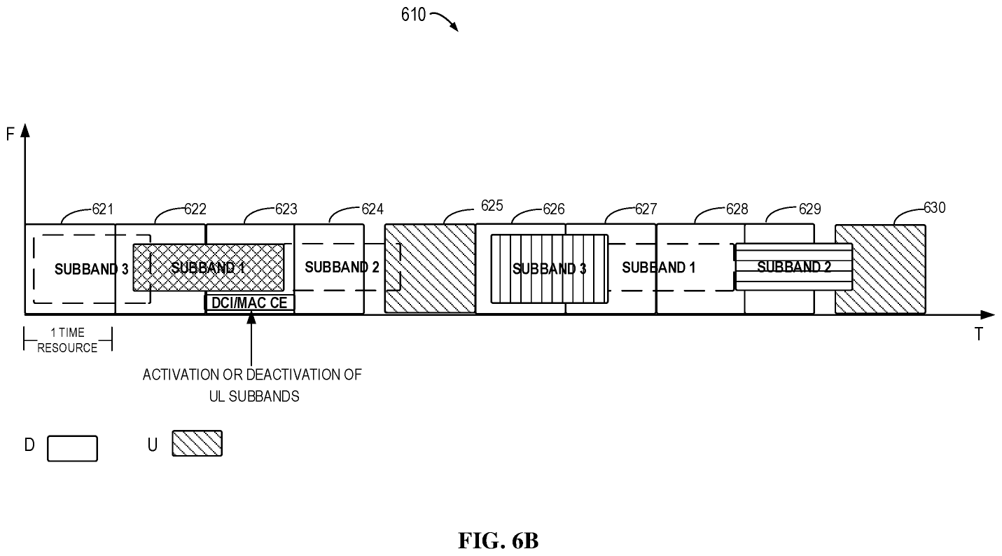

In some example embodiments, the first device 110 may determine 315, based on the first and second configuration information, a third subset of the resources comprising the first and second subsets of the resources. Based on the received information, the UE is able to determine respective UL or DL direction or UL-DL split for each resource in the time and frequency grid, which will be discussed later in connection with FIG. 6A.

Accordingly, the first device 110 may transmit 320 to the second device 120 a data transmission on the third subset of the resources.

The semi-statistically signaling of SBFD configurations has been described above. In the following, dynamically signaling of SBFD configurations will be discussed in detail, which may be used together with the semi-statistically signaling. In this case, the second configuration information may indicate at least frequency domain allocation of the at least one second subset of the resources. The second device 120 may further transmit 325 a configuration message to the first device 110 for indicating activation or deactivation of the at least one second subset of the resources in time domain. The configuration message may be transmitted via lower layer signaling, for example, DCI, medium access control (MAC) control element (CE).

In some example embodiments, such a configuration message may be used to activate or deactivate each of the individual subbands that correspond to the at least one second subset of the resources.

In the above embodiments, after receiving the configuration message, the first device 110 may determine 330 whether the configuration message includes a first indication of activating at least a first part of the at least one second subset of the resources, or a second indication of deactivating at least a second part of the at least one second subset of the resources.

If the configuration message comprises the first indication, the first device 110 may determine a third subset of the resources assigned for uplink transmissions based on the first indication. In this case, the third subset of the resources may include the first subset of the resources and the at least first part of the at least one second subset of the resources. Accordingly, the first device 110 may transmit 335 to the second device 120 a data transmission on the third subset of the resources,

Otherwise, if the configuration message comprises the second indication, the first device 110 may determine a fourth subset of the resources assigned for uplink transmissions based on the second indication. In this case, the fourth subset of the resources may include the first subset of the resources and a rest of the at least one second subset of the resources other than the at least the second part. Accordingly, the first device 110 may transmit 340 to the second device 120.

For frequency domain allocation, the second configuration information may include a starting frequency resource and a bandwidth of an uplink sub-band corresponding to one of the at least one second subset of the resources. Alternatively, the second configuration information may include a starting frequency resource and an end frequency resource of an uplink sub-band corresponding to the second subset of the resources. For time domain allocation, the first configuration information may indicate the TDD-UL-DL-Pattern for the first device 110. Additionally, the configuration message may include an indication of at least one slot of the TDD-UL-DL-Pattern applying the uplink sub-band.

In some example embodiments, the indication may be a bitmap for indicating D and/or S slots of the TDD-UL-DL-Pattern on which the configured or active UL subband is applied. In case of a plurality of UL subbands to be applied, an indication of the active subband is needed, this will be discussed later. In this case, it is assumed that the UL resource starts from the first symbol of each indicated slot, or alternatively the start symbol of the first indicated slot maybe configured, and the other slots indicated will convert all the DL and/or flexible symbols as SBFD symbols.

In some example embodiments, the bitmap is with a number of bits corresponding to a number of D and S slots in the TDD-UL-DL-Pattern. By way of example, for TDD-UL-DL-Pattern “DDDSU”, a bitmap for indicating the active subband is applicable for the second and third D slots and S slot may be 0111.

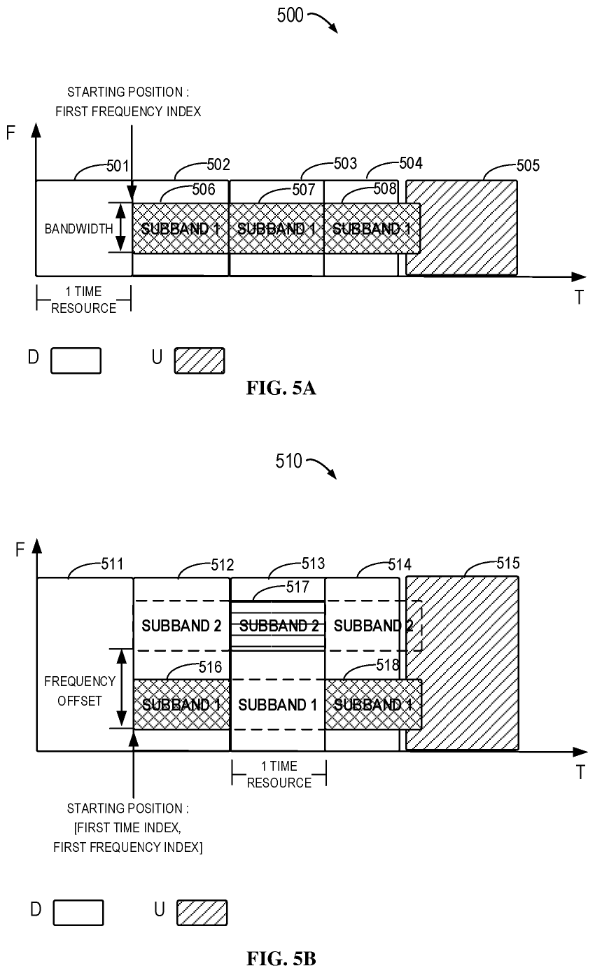

FIG. 5A illustrates a schematic diagram of an example configuration 500 of UL subbands according to some example embodiments of the present disclosure. As shown in FIG. 5A, slots 501 to 504 are assigned for DL transmissions, while slot 505 is assigned for UL transmission, as indicated by the first configuration information. The second configuration indication indicates a frequency domain allocation of UL-DL splits 506 to 508.

Taking UL-DL split 506 as a representative, the second configuration information may indicate a starting position and a bandwidth of the corresponding subband 1. For example, the starting PRB may be indicated by the first time index. In addition, the bandwidth may be indicted by the number of frequency resources (e.g., PRBs) in frequency domain. Additionally, or alternatively, in some embodiments, the second configuration information may further indicate the starting symbol for the first slot in the UL-DL splits 506 to 508 (i.e., the UL-DL split 506), and full slot allocation is assumed for the rest of the UL-DL splits 506 to 508.

Alternatively, for reducing the number of bits needed for the bitmap, a table may be specified or configured for each TDD pattern to indicate only relevant possibilities of using the active UL subband in time domain. In this way, the gNB can change the SBFD configuration in time domain in a dynamic and flexible manner.

For instance, mapping of the bitmap of 2 bits with the TDD-UL-DL-Pattern “DDDSU” is shown in Table 1. It should be understood that such an approach is also applicable in a case where more than one TDD-UL-DL-Pattern is configured.

TABLE 1
An example of a 2-bit bitmap for TDD-UL-DL-Pattern “DDDSU”

| | Slots having UL resource in DDDSU |
|---|---|
| Bitmap | pattern are underlined |
| 00 | DDDSU (no SBFD) |
| 01 | DDDSU |
| 10 | DDDSU |
| 11 | DDDSU |

Alternatively, in another example configuration of UL subbands, at least two non-overlapping UL subbands may be configured for SBFD frame, which have the same bandwidth and time domain allocation, for example, a nominal time domain allocation. One of the UL subbands is separated from another by an offset in frequency domain. In this case, the second configuration information may indicate a starting time resource and a starting frequency resource of one of the UL subbands (e.g., in a form of [first time index, first frequency index]) and the frequency offset. Accordingly, the position of another subband can be determined based on the frequency offset.

FIG. 5B illustrates a schematic diagram of another example configuration 510 of UL subbands according to some example embodiments of the present disclosure. As shown in FIG. 5B, slots 511 to 514 are assigned for DL transmissions, while slot 515 is assigned for UL transmission, as indicated by the first configuration information. Two non-overlapping UL subbands 1 and 2 having the same bandwidth and nominal time domain allocation are configured for SBFD frame. The UL subband 2 is separate from the UL subband 1 by a frequency offset, which may be the offset for frequency hopping.

Additionally, in some example embodiments, for each time instance (e.g., slot, symbol, etc.), only one of the UL subbands 1 and 2 may be used. This is beneficial to UL transmission and DL reception filtering at UE side. The second device 120 may dynamically indicate which subband is active for UL, and the reference point for frequency domain allocation follows the activated subband.

Additionally, or alternatively, in a case where the frequency hopping is enabled, the two subbands 1 and 2 may be used alternatively in time domain. The starting frequency hop is on an active subband, which is indicated independently. Furthermore, in a case where more than two UL subbands are configured, an indication of which two of more than two subbands are to be used for frequency hopping should also be dynamically or semi-statically indicated.

In some example embodiments, TDD-UL-DL-Pattern RRC configuration element may be extended to include one or more UL subbands that apply for the corresponding TDD-UL-DL-Pattern. This allows to implement ‘non-symmetrical’ SBFD subframe configurations by assigning TDD pattern 1 and TDD pattern 2 with different subband configurations, for example, DXXXU-DDDXU. FIG. 6A illustrates a schematic diagram of an example assignment 600 of UL subbands to TDD-UL-DL pattern according to some example embodiments of the present disclosure.

As shown in FIG. 6A, TDD pattern 1 “DDDSU” corresponding to slots 601 to 605 is concatenated to TDD pattern 2 “DDSUU” corresponding to slots 606 to 610. At least one set of UL subbands 1 and 3 may overlap with DL, UL or flexible symbols in time domain. The DL symbols/slots that overlap with the at least one set of UL subbands may be regarded as SBFD symbols/slots. This may be regarded as the RRC or higher-layer configured SBFD UL-DL pattern which can be used for the purposes of initial access (e.g., random access channel), as well as for determining a validity of certain semi-static signals e.g., physical downlink control channel (PDCCH), channel state information reference signal (CSI-RS), etc.

To allow dynamic adaptation of the SBFD subband configuration, multiple UL subbands may be configured via higher layer indication (e.g., RRC signaling), while lower layer indication (e.g., MAC CE or new DCI format) may be used to activate or deactivate one or more UL subbands in a dynamic manner, e.g., DCI or MAC CE may provide a bitmap, e.g., 10011 to activate or deactivate each of the individual subbands.

Note that not all UL subbands need to be assigned to the RRC/SIB-provided TDD-UL-DL-pattern, as lower layer signaling (e.g., via MAC, DCI, etc.) may be also used to determine which UL subbands shall be regarding valid or active by the UE at a certain time.

FIG. 6B illustrates a schematic diagram of an example configuration 610 of dynamic activation or deactivation of UL subbands according to some example embodiments of the present disclosure. As shown in FIG. 6B, the first device 110 receives the configuration message via lower layer signaling e.g., MAC, DCI, etc. for changing the UL subband configuration. In the example of FIG. 6B, the MAC or DCI includes a bitmap “011”.

Accordingly, the first device 110 applies the received UL subband configuration after a predetermined time from the reception of the configuration message. Thus, in the slots 621 to 625, the subbands 2 and 3 are deactivated and the subband 1 is activated, while in the slots 626 to 630, the states of the subbands 1 to 3 are toggled, i.e., the subbands 2 and 3 are activated and the subband 1 is deactivated.

In some example embodiments, a new MAC CE or DCI format may be used to activate or deactivate each of the individual subbands. For instance, the DCI or MAC CE provides a bitmap, e.g., 0110 where each of the bits is mapped to a corresponding one of the four (pre-) configured UL subands. As an option, ‘1’ and ‘0’ may be used to indicate which UL subbands shall be regarded as enabled and disabled, respectively. As another option, the value of ‘1’ toggles the activation/deactivation state of the corresponding subband, in other words, it is used to switch the state of the subband from enabled to disabled or from disabled to enabled.

It should be understood that other options with a mix of higher-layer signaling and lower-layer signaling are also possible for implementing the embodiments. For example, a table with multiple possible enabled or disabled states, e.g., 0101, 0111,0000,1010, may be provided via a RRC signaling, and a 2-bit indication in DCI or MAC CE points to one of the 4 entries in the table. Therefore, the present disclosure is not limited in this regard.

In some example embodiments, a similar approach as used for dynamically signaling the SFI using DCI format 2_0 with dynamic TDD may be reused for SBFD operation. In this case, the frequency domain allocation of D-U split is configured via higher layer signaling (e.g., RRC, MAC, etc.). The time granularity for indicating SBFD operation can be on an OFDM-symbol level. One or more table of slot formats is configured at the first device 110, which indicates multiple options for the UL-DL resource split with a time resolution of one OFDM-symbol. For example, a similar table as Table 11.1.1-1 in TS 38.213 may be used for this end, where ‘F’ symbols are replaced with ‘SBFD’ symbols.

Instead of using a new table, a subset of the unused indexes 66-254 of Table 11.1.1-1 in TS 38.213 may be used for signaling of SBFD symbols, e.g., indexes 60-115 could be used to signal the same slot formats as with indexes 0-55 but replacing ‘F’ symbols with ‘SBFD’ symbols. In some embodiments, the gNB may transmit one DCI 2_0 per cell. The UEs that do not support SBFD operations interpret ‘F’ symbols according to Table 11.1.1-1 in TS 38.213 as flexible symbols, while SBFD-aware UEs interpret the ‘F’ symbols as SBFD symbols with frequency domain UL-DL split as configured by higher layers. Additionally, in some cases, the SBFD-aware UEs may be further configured via higher layer signaling of whether to interpret ‘F’ symbols according to Table 11.1.1-1 in TS 38.213 as flexible symbols or SBFD symbols.

Alternatively, in some other embodiments, the gNB may configure the UEs not supporting SBFD operations and the SBFD-aware UEs via two separate DCI 2_0. In this case, the SFI is signaled separately to the UEs not supporting SBFD operations and the SBFD-aware UEs. The indexes may either point to two different tables, i.e., the Table 11.1.1-1 in TS 38.213 for UEs not supporting SBFD operations and a new table for the SBFD-aware UEs and for SBFD-aware UEs, or to the same extended Table 11.1.1-1 in TS 38.213.

An example of slot formats available for SBFD operation is shown in Table 2. For example, one entry may be defined as D, X2, X2, X2, U, U, X3, X3, X3, X3, X3, U, U, U, where ‘Xn’ denotes a SBFD symbol with UL-DL split in frequency domain as configured in the SBFD_UL_subband_n.

TABLE 2
Slot formats available for SBFD operation

| . | . | | | | | | | | | | | | | |
|---|---|---|---|---|---|---|---|---|---|---|---|---|---|---|
| . | . | | | | | | | | | | | | | |
| . | . | | | | | | | | | | | | | |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |
| 56 | D | X2 | X2 | X2 | U | U | X3 | X3 | X3 | X3 | X3 | U | U | U |
| 57 | D | D | X2 | X2 | X4 | X4 | X4 | X3 | X3 | X3 | X3 | X3 | U | U |

| | |
|---|---|
| 58- | . |
| 254 | . |
| | . |
| 255 | UE determines the slot format for the slot based on |
| | tdd-UL-DL-ConfigurationCommon, or |
| | tdd-UL-DL-ConfigurationDedicated and, |
| | if any, on detected DCI formats |

It should be understood that some of the steps in process 200 is optional or can be omitted, and the order of the steps is given for an illustrative purpose. Thus, the embodiments of the present disclosure are not limited in this regard.

According to the example embodiments of the present disclosure, a solution of SBFD frame structure and related configurations. The configurations of the UL-DL split and UL subbands are flexible, i.e., the location and size of the UL-DL PRB split may be configured, e.g., at a cell level or at an operator level, or may even change over time in each individual cell. To this end, one or more signaling is enabled by the gNB for configurating, activating or deactivating the UL-DL PRB split. In addition, non-symmetrical SBFD subframe configurations by assigning TDD pattern 1 and pattern 2 with different subband configurations are possible.

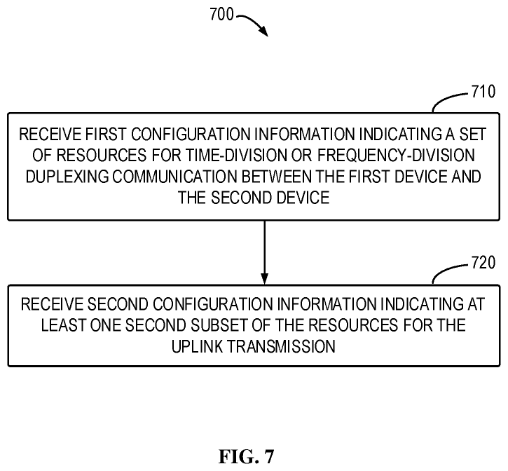

FIG. 7 illustrates a flowchart of an example method 700 according to some example embodiments of the present disclosure. The method 700 can be implemented at a terminal device, for example, the first device 110 described with reference to FIG. 1. For the purpose of discussion, the method 700 will be described with reference to FIG. 1.

At 710, the first device 110 receives, from a second device 120, first configuration information indicating a set of resources for time-division or frequency-division duplexing communication between the first device 110 and the second device 120. The set of resources may comprise a first subset of the resources for uplink transmission.

At 720, the first device 110 receives, from the second device 120, second configuration information indicating at least one second subset of the resources for the uplink transmission. The at least one second subset of the resources may comprise at least one resource other than the first subset of the resources.

In some example embodiments, the first subset of the resources may not overlap with the at least one second subset of the resources. Additionally, or alternatively, at least a part of the first subset of the resources may overlap with the at least one second subset of the resources.

In some example embodiments, the second configuration information may comprise:
a first indication of a starting frequency resource and a starting time resource of one of the at least one second subset of the resources, and
a second indication of an end frequency resource and an end time resource of the second subset of the resources.

In some example embodiments, the second configuration information may comprise a starting frequency resource and a starting time resource of one of the at least one second subset of the resources, a first number of frequency resources in the second subset, and a second number of time resources in the second subset.

In some example embodiments, the at least one second subset of the resources may comprise a first target subset of the resources and a second target subset of the resources. In this case, the second configuration information may comprise:
a third indication of a starting frequency resource and a starting time resource of the first target subset of the resources, and a first bandwidth of a first uplink subband corresponding to the first target subset of the resources, and
a fourth indication of a starting frequency resource and a starting time resource of the second target subset of the resources, and a second bandwidth of a second uplink subband corresponding to the second target subset of the resources,
   Additionally, in these embodiments, the starting time resource of the second target subset of the resources may be the first symbol after an end time resource of the first target subset of the resources in time domain.

In some example embodiments, the second configuration information may comprise:
a first resource indicator value indicating a starting frequency resource and a number of frequency resources in one of the at least one second subset of the resources; and
a second resource indicator value indicating a starting time resource and a duration of time resources in the second subset of resources.

In some example embodiments, the second configuration information may be contained in one of a system information block (SIB) or a radio resource control (RRC) message.

In some example embodiments, the first device 110 may determine, based on the first and second configuration information, a third subset of the resources comprising the first and second subsets of the resources. The first device 110 may then transmit a data transmission on the third subset of the resources to the second device 120.

In some example embodiments, the second configuration information may indicate the at least one second subset of the resources in frequency domain. The first device 110 may receive from the second device 120 a configuration message indicating the at least one second subset of the resources in time domain.

Additionally, or alternatively, in the above embodiments, the second configuration information comprises one of the following:
a starting frequency resource and a bandwidth of an uplink subband corresponding to one of the at least one second subset of the resources, or
a starting frequency resource and an end frequency resource of an uplink subband corresponding to the second subset of the resources.

In some example embodiments, the first configuration information may indicate a time division duplexing pattern for the first device 110. The configuration message may comprise an indication of at least one slot of the time division duplexing pattern applying the uplink subband.

Additionally, or alternatively, in the above embodiments, the indication may be a bitmap with a number of bits corresponding to a number of at least one of the following:
a plurality of downlink slots or symbols in the time division duplexing pattern, or
at least one special slot or symbol in the time division duplexing pattern.

In this case, a first value of a bit in the bitmap may indicate a corresponding slot or symbol applying an uplink subband corresponding to one of the at least one second subset of the resources. Additionally, or alternatively, a second value of the bit in the bitmap may indicate the corresponding slot or symbol not applying the uplink subband.

In some example embodiments, a plurality of values of the bitmap may indicate a plurality of combinations of at least one of the following applying the uplink subband:
a plurality of downlink slots or symbols in the time division duplexing pattern, or
at least one special slot or symbol in the time division duplexing pattern.
   In this case, the mapping of the plurality of values and the plurality of combinations may be preconfigured or predetermined at the first device 110 and the second device 120.

In some example embodiments, a starting time resource of a second subset of the resources may be the first symbol of a corresponding slot indicated by the bitmap.

In some example embodiments, a starting time resource of a first one of the second subsets may be indicated by the second device 120. Furthermore, a starting time resource of a rest of the second subsets may be the first symbol of a corresponding slot indicated by the bitmap.

In some example embodiments, the second configuration information may indicate a first target subset of the resources in time domain and a frequency offset. The first device 110 may determine at least one second target subset of the resources based on the first target subset of the resources in time domain and the frequency offset. In this case, the first target subset of the resources may correspond to a first uplink subband. Additionally, or alternatively, the at least one second target subset of the resources may correspond to at least one second uplink subband.

In some example embodiments, the frequency offset may correspond to a frequency hopping associated with the first device 110. The first uplink subband and the at least one second uplink subband may be alternatively applied in time domain.

In some example embodiments, the first configuration information may indicate a first time division duplexing pattern and a second time division duplexing pattern for the first device 110. Additionally, or alternatively, the second configuration message may comprise at least one first uplink subband assigned to the first time division duplexing pattern and at least one second uplink subband assigned to the second time division duplexing pattern.

In some example embodiments, the second configuration information may indicate the at least one second subset of the resources in frequency domain. In this case, the first device 110 may receive, from the second device 120, DCI comprising a SFI corresponding to the at least one second subset of the resources in time domain. The first device 110 may determine a third subset of the resources assigned for uplink transmissions based on the slot format indicator. In this case, the third subset of the resources may comprise the first subset of the resources and the at least one second subset of the resources. Accordingly, the first device may transmit to the second device 120 a data transmission on the third subset of the resources.

In some example embodiments, the first device 110 may receive a configuration message from the second device 120. If the configuration message comprises a first indication of activating at least a first part of the at least one second subset of the resources, the first device 110 may determine a third subset of the resources assigned for uplink transmissions based on the first indication. The third subset of the resources may comprise the first subset of the resources and the at least first part of the at least one second subset of the resources. The first device 110 may then transmit to the second device 120 a data transmission on the third subset of the resources.

Otherwise, in some example embodiments, if the configuration message comprises a second indication of deactivating at least a second part of the at least one second subset of the resources, the first device 110 may determine a fourth subset of the resources assigned for uplink transmissions based on the second indication. The fourth subset of the resources may comprise the first subset of the resources and a rest of the at least one second subset of the resources other than the at least the second part. The first device 110 may then transmit to the second device 120 a data transmission on the fourth subset of the resources.

In some example embodiments, the configuration message may comprise DCI, MAC CE, or so on.

In some example embodiments, the first device 110 may comprise a terminal device, and the second device 120 may comprise a network device. Alternatively, in some other embodiments, the first device 110 may comprise a network device, and the second device 120 may comprise a terminal device.

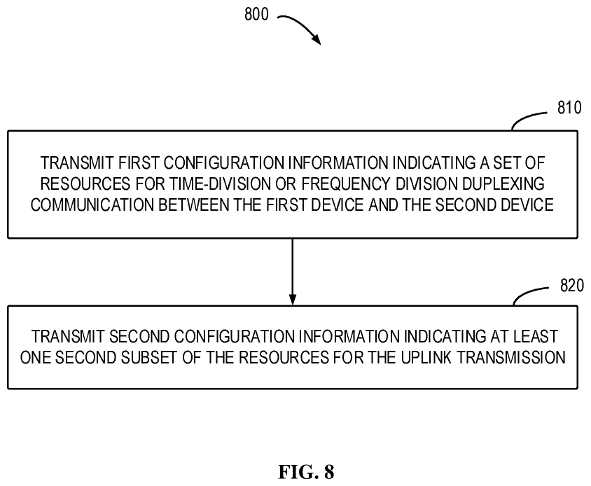

FIG. 8 illustrates a flowchart of an example method 800 according to some example embodiments of the present disclosure. The method 800 can be implemented at a network device, for example, the second device 120 described with reference to FIG. 1. For the purpose of discussion, the method 800 will be described with reference to FIG. 1.

At 810, the second device 120 transmits to a first device 110 first configuration information indicating a set of resources for time-division or frequency division duplexing communication between the first device 110 and the second device 120. The set of resources may comprise a first subset of the resources for uplink transmission.

At 820, the second device 120 transmits to the first device 110 second configuration information indicating at least one second subset of the resources for the uplink transmission, the at least one second subset of the resources comprising at least one resource other than the first subset of the resource.

In some example embodiments, the first subset of the resources may not overlap with the at least one second subset of the resources. Additionally, or alternatively, at least a part of the first subset of the resources may overlap with the at least one second subset of the resources.

In some example embodiments, the second configuration information may comprise:
a first indication of a starting frequency resource and a starting time resource of one of the at least one second subset of the resources, and
a second indication of an end frequency resource and an end time resource of the second subset of the resources.

In some example embodiments, the second configuration information may comprise a starting frequency resource and a starting time resource of one of the at least one second subset of the resources, a first number of frequency resources in the second subset, and a second number of time resources in the second subset.

In some example embodiments, the at least one second subset of the resources may comprise a first target subset of the resources and a second target subset of the resources. In this case, the second configuration information may comprise:
a third indication of a starting frequency resource and a starting time resource of the first target subset of the resources, and a first bandwidth of a first uplink subband corresponding to the first target subset of the resources, and
a fourth indication of a starting frequency resource and a starting time resource of the second target subset of the resources, and a second bandwidth of a second uplink subband corresponding to the second target subset of the resources,
   Additionally, in these embodiments, the starting time resource of the second target subset of the resources may be the first symbol after an end time resource of the first target subset of the resources in time domain.

In some example embodiments, the second configuration information may comprise:
a first resource indicator value indicating a starting frequency resource and a number of frequency resources in one of the at least one second subset of the resources; and
a second resource indicator value indicating a starting time resource and a duration of time resources in the second subset of resources.

In some example embodiments, the second configuration information may be contained in one of a system information block (SIB) or a radio resource control (RRC) message.

In some example embodiments, the second device 120 may receive, from the first device 110, a data transmission on a third subset of the resources comprising the first and second subsets of the resources.

In some example embodiments, the second configuration information may indicate the at least one second subset of the resources in frequency domain. The second device 120 may transmit, to the first device 110, a configuration message indicating the at least one second subset of the resources in time domain.

In some example embodiments, the second configuration information may comprise one of the following:
a starting frequency resource and a bandwidth of an uplink subband corresponding to one of the at least one second subset of the resources, or;
a starting frequency resource and an end frequency resource of an uplink subband corresponding to the second subset of the resources.

In some example embodiments, the first configuration information may indicate a time division duplexing pattern for the first device 110, and the configuration message comprises an indication of at least one slot of the time division duplexing pattern applying the uplink subband.

In some example embodiments, the indication may be a bitmap with a number of bits corresponding to a number of at least one of the following:
a plurality of downlink slots or symbols in the time division duplexing pattern, or
at least one special slot or symbol in the time division duplexing pattern.
   In this case, a first value of a bit in the bitmap may indicate a corresponding slot or symbol applying an uplink subband corresponding to one of the at least one second subset of the resources. Additionally, or alternatively, a second value of the bit in the bitmap may indicate the corresponding slot or symbol not applying the uplink subband.

In some example embodiments, a plurality of values of the bitmap may indicate a plurality of combinations of at least one of the following applying the uplink subband:
a plurality of downlink slots or symbols in the time division duplexing pattern, or
at least one special slot or symbol in the time division duplexing pattern.
   In this case, the mapping of the plurality of values and the plurality of combinations may be preconfigured or predetermined at the first device 110 and the second device 120.

In some example embodiments, a starting time resource of a second subset of the resources may be the first symbol of a corresponding slot indicated by the bitmap.

In some example embodiments, a starting time resource of a first one of the second subsets may be indicated by the second device 120. Furthermore, a starting time resource of a rest of the second subsets may be the first symbol of a corresponding slot indicated by the bitmap.

In some example embodiments, the second configuration information may indicate a first target subset of the resources in time domain and a frequency offset between the first target subset of the resources and at least one second target subset of the resources in time domain. The first target subset of the resources may correspond to a first uplink subband, and the at least one second target subset of the resources may correspond to at least one second uplink subband.

In some example embodiments, the frequency offset may correspond to a frequency hopping associated with the first device 110. The first uplink subband and the at least one second uplink subband may be alternatively applied in time domain.

In some example embodiments, the first configuration information may indicate a first time division duplexing pattern and a second time division duplexing pattern for the first device 110. Additionally, or alternatively, the second configuration message may comprise at least one first uplink subband assigned to the first time division duplexing pattern and at least one second uplink subband assigned to the second time division duplexing pattern.

In some example embodiments, the second configuration information may indicate the at least one second subset of the resources in frequency domain. In this case, the second device 120 may transmit, to the first device 110, DCI comprising a SFI corresponding to the at least one second subset of the resources in time domain. Accordingly, the second device 120 may receive from the first device 110 a data transmission on a third subset of the resources comprising the first subset of the resources and the at least one second subset of the resources.

In some example embodiments, the second device 120 may transmit, to the first device 110, a configuration message comprising a first indication of activating at least a first part of the at least one second subset of the resources. The second device 120 may then receive, from the first device 110, a data transmission on a third subset of the resources comprising the first subset of the resources and the at least first part of the at least one second subset of the resources.

In some example embodiments, the second device 120 may transmit, to the first device 110, a configuration message comprising a second indication of deactivating at least a second part of the at least one second subset of the resources. The second device 120 may then receive, from the first device 110, a data transmission on a fourth subset of the resources comprising the first subset of the resources and a rest of the at least one second subset of the resources other than the at least the second part.

In some example embodiments, the configuration message may comprise DCI, MAC CE, or so on.

In some example embodiments, the first device 110 may comprise a terminal device, and the second device 120 may comprise a network device. Alternatively, in some other embodiments, the first device 110 may comprise a network device, and the second device 120 may comprise a terminal device.

In some example embodiments, a first apparatus capable of performing the method 700 (for example, the first device 110) may comprise means for performing the respective steps of the method 700. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the apparatus.

In some example embodiments, the first apparatus comprises: means for receiving, from a second apparatus, first configuration information indicating a set of resources for time-division or frequency-division duplexing communication between the first apparatus and the second apparatus, the set of resources comprising a first subset of the resources for uplink transmission; and means for receiving, from the second apparatus, second configuration information indicating at least one second subset of the resources for the uplink transmission, the at least one second subset of the resources comprising at least one resource other than the first subset of the resources.

In some example embodiments, the first subset of the resources is not overlapping with the at least one second subset of the resources.

In some example embodiments, at least a part of the first subset of the resources is overlapping with the at least one second subset of the resources.

In some example embodiments, the second configuration information comprises: a first indication of a starting frequency resource and a starting time resource of one of the at least one second subset of the resources, and a second indication of an end frequency resource and an end time resource of the second subset of the resources.

In some example embodiments, the second configuration information comprises a starting frequency resource and a starting time resource of one of the at least one second subset of the resources, a first number of frequency resources in the second subset, and a second number of time resources in the second subset.

In some example embodiments, the at least one second subset of the resources comprises a first target subset of the resources and a second target subset of the resources, and the second configuration information comprises: a third indication of a starting frequency resource and a starting time resource of the first target subset of the resources, and a first bandwidth of a first uplink subband corresponding to the first target subset of the resources, and a fourth indication of a starting frequency resource and a starting time resource of the second target subset of the resources, and a second bandwidth of a second uplink subband corresponding to the second target subset of the resources, wherein the starting time resource of the second target subset of the resources is the first symbol after an end time resource of the first target subset of the resources in time domain.

In some example embodiments, the second configuration information comprises: a first resource indicator value indicating a starting frequency resource and a number of frequency resources in one of the at least one second subset of the resources; and a second resource indicator value indicating a starting time resource and a duration of time resources in the second subset of resources.

In some example embodiments, the second configuration information is contained in one of a system information block or a radio resource control message.

In some example embodiments, the first apparatus further comprises: means for determining, based on the first and second configuration information, a third subset of the resources comprising the first and second subsets of the resources; and means for transmitting, to the second apparatus, a data transmission on the third subset of the resources.

In some example embodiments, the second configuration information indicates the at least one second subset of the resources in frequency domain. The first apparatus further comprises: means for receiving, from the second apparatus, a configuration message indicating the at least one second subset of the resources in time domain.

In some example embodiments, the second configuration information comprises one of the following: a starting frequency resource and a bandwidth of an uplink subband corresponding to one of the at least one second subset of the resources, or a starting frequency resource and an end frequency resource of an uplink subband corresponding to the second subset of the resources.

In some example embodiments, the first configuration information indicates a time division duplexing pattern for the first apparatus, and the configuration message comprises an indication of at least one slot of the time division duplexing pattern applying the uplink subband.

In some example embodiments, the indication is a bitmap with a number of bits corresponding to a number of at least one of the following: a plurality of downlink slots or symbols in the time division duplexing pattern, or at least one special slot or symbol in the time division duplexing pattern, and wherein a first value of a bit in the bitmap indicates a corresponding slot or symbol applying an uplink subband corresponding to one of the at least one second subset of the resources, and a second value of the bit in the bitmap indicates the corresponding slot or symbol not applying the uplink subband.

In some example embodiments, a plurality of values of the bitmap indicates a plurality of combinations of at least one of the following applying the uplink subband: a plurality of downlink slots or symbols in the time division duplexing pattern, or at least one special slot or symbol in the time division duplexing pattern, and wherein mapping of the plurality of values and the plurality of combinations is preconfigured or predetermined at the first apparatus and the second apparatus.

In some example embodiments, a starting time resource of a second subset of the resources is the first symbol of a corresponding slot indicated by the bitmap.

In some example embodiments, a starting time resource of a first one of the second subsets is indicated by the second apparatus, and a starting time resource of a rest of the second subsets is the first symbol of a corresponding slot indicated by the bitmap.

In some example embodiments, the second configuration information indicates a first target subset of the resources in time domain and a frequency offset. The first apparatus further comprises: means for determining at least one second target subset of the resources based on the first target subset of the resources in time domain and the frequency offset, wherein the first target subset of the resources corresponds to a first uplink subband, the at least one second target subset of the resources corresponds to at least one second uplink subband.

In some example embodiments, the frequency offset corresponds to a frequency hopping associated with the first apparatus, and the first uplink subband and the at least one second uplink subband are alternatively applied in time domain.

In some example embodiments, the first configuration information indicates a first time division duplexing pattern and a second time division duplexing pattern for the first apparatus, and the second configuration message comprises at least one first uplink subband assigned to the first time division duplexing pattern and at least one second uplink subband assigned to the second time division duplexing pattern.

In some example embodiments, the second configuration information indicates the at least one second subset of the resources in frequency domain, and the first apparatus further comprises: means for receiving, from the second apparatus, downlink control information comprising a slot format indicator corresponding to the at least one second subset of the resources in time domain; means for determining a third subset of the resources assigned for uplink transmissions based on the slot format indicator, the third subset of the resources comprising the first subset of the resources and the at least one second subset of the resources; and means for transmitting, to the second apparatus, a data transmission on the third subset of the resources.

In some example embodiments, the first apparatus further comprises: means for receiving a configuration message from the second apparatus; means for in accordance with a determination that the configuration message comprises a first indication of activating at least a first part of the at least one second subset of the resources, determining a third subset of the resources assigned for uplink transmissions based on the first indication, the third subset of the resources comprising the first subset of the resources and the at least first part of the at least one second subset of the resources; and means for transmitting, to the second apparatus, a data transmission on the third subset of the resources.

In some example embodiments, first apparatus further comprises: means for in accordance with a determination that the configuration message comprises a second indication of deactivating at least a second part of the at least one second subset of the resources, determining a fourth subset of the resources assigned for uplink transmissions based on the second indication, the fourth subset of the resources comprising the first subset of the resources and a rest of the at least one second subset of the resources other than the at least the second part; and means for transmitting, to the second apparatus, a data transmission on the fourth subset of the resources.

In some example embodiments, the configuration message comprises one of downlink control information or a medium access control element.

In some example embodiments, the first apparatus comprises a terminal device, and the second apparatus comprises a network device.

In some example embodiments, a second apparatus capable of performing the method 800 (for example, the second device 120) may comprise means for performing the respective steps of the method 800. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the apparatus.

In some example embodiments, the second apparatus comprises: means for transmitting, to a first apparatus, first configuration information indicating a set of resources for time-division or frequency division duplexing communication between the first apparatus and the second apparatus, the set of resources comprising a first subset of the resources for uplink transmission; and means for transmitting, to the first apparatus, second configuration information indicating at least one second subset of the resources for the uplink transmission, the at least one second subset of the resources comprising at least one resource other than the first subset of the resources.

In some example embodiments, the first subset of the resources is not overlapping with the at least one second subset of the resources.

In some example embodiments, at least a part of the first subset of the resources is overlapping with the at least one second subset of the resources.

In some example embodiments, the second configuration information comprises: a first indication of a starting frequency resource and a starting time resource of one of the at least one second subset of the resources, and a second indication of an end frequency resource and an end time resource of the second subset of the resources.

In some example embodiments, the second configuration information comprises a starting frequency resource and a starting time resource of one of the at least one second subset of the resources, a first number of frequency resources in the second subset, and a second number of time resources in the second subset.

In some example embodiments, the at least one second subset of the resources comprises a first target subset of the resources and a second target subset of the resources, and the second configuration information comprises: a third indication of a starting frequency resource and a starting time resource of the first target subset of the resources, and a first bandwidth of a first uplink subband corresponding to the first target subset of the resources, and a fourth indication of a starting frequency resource and a starting time resource of the second target subset of the resources, and a second bandwidth of a second uplink subband corresponding to the second target subset of the resources, wherein the starting time resource of the second target subset of the resources is the first symbol after an end time resource of the first target subset of the resources in time domain.

In some example embodiments, the second configuration information comprises: a first resource indicator value indicating a starting frequency resource and a number of frequency resources in one of the at least one second subset of the resources; and a second resource indicator value indicating a starting time resource and a duration of time resources in the second subset of resources.

In some example embodiments, the second configuration information is contained in one of a system information block or a radio resource control message.

In some example embodiments, the second apparatus further comprises: means for receiving, from the first apparatus, a data transmission on a third subset of the resources comprising the first and second subsets of the resources.

In some example embodiments, the second configuration information indicates the at least one second subset of the resources in frequency domain, and second apparatus further comprises: means for transmitting, to the first apparatus, a configuration message indicating the at least one second subset of the resources in time domain.

In some example embodiments, the second configuration information comprises one of the following: a starting frequency resource and a bandwidth of an uplink subband corresponding to one of the at least one second subset of the resources, or a starting frequency resource and an end frequency resource of an uplink subband corresponding to the second subset of the resources.

In some example embodiments, the first configuration information indicates a time division duplexing pattern for the first apparatus, and the configuration message comprises an indication of at least one slot of the time division duplexing pattern applying the uplink subband.

In some example embodiments, the indication is a bitmap with a number of bits corresponding to a number of at least one of the following: a plurality of downlink slots or symbols in the time division duplexing pattern, or at least one special slot or symbol in the time division duplexing pattern, and wherein a first value of a bit in the bitmap indicates a corresponding slot or symbol applying an uplink subband corresponding to one of the at least one second subset of the resources, and a second value of the bit in the bitmap indicates the corresponding slot or symbol not applying the uplink subband.

In some example embodiments, a plurality of values of the bitmap indicates a plurality of combinations of at least one of the following applying the uplink subband: a plurality of downlink slots or symbols in the time division duplexing pattern, or at least one special slot or symbol in the time division duplexing pattern, and wherein mapping of the plurality of values and the plurality of combinations is preconfigured or predetermined at the first apparatus and the second apparatus.

In some example embodiments, a starting time resource of a second subset of the resources is the first symbol of a corresponding slot indicated by the bitmap.

In some example embodiments, a starting time resource of a first one of the second subsets is indicated by the second apparatus, and a starting time resource of a rest of the second subsets is the first symbol of a corresponding slot indicated by the bitmap.

In some example embodiments, the second configuration information indicates a first target subset of the resources in time domain and a frequency offset between the first target subset of the resources and at least one second target subset of the resources in time domain, the first target subset of the resources corresponds to a first uplink subband, the at least one second target subset of the resources corresponds to at least one second uplink subband.

In some example embodiments, the frequency offset corresponds to a frequency hopping associated with the first apparatus, and the first uplink subband and the at least one second uplink subband are alternatively applied in time domain.

In some example embodiments, the first configuration information indicates a first time division duplexing pattern and a second time division duplexing pattern for the first apparatus, and the second configuration message comprises at least one first uplink subband assigned to the first time division duplexing pattern and at least one second uplink subband assigned to the second time division duplexing pattern.

In some example embodiments, the second configuration information indicates the at least one second subset of the resources in frequency domain, and the second apparatus further comprises: means for transmitting, to the first apparatus, downlink control information comprising a slot format indicator corresponding to the at least one second subset of the resources in time domain; and means for receiving, from the first apparatus, a data transmission on a third subset of the resources comprising the first subset of the resources and the at least one second subset of the resources.

In some example embodiments, the second apparatus further comprises: means for transmitting, to the first apparatus, a configuration message comprising a first indication of activating at least a first part of the at least one second subset of the resources; and means for receiving, from the first apparatus, a data transmission on a third subset of the resources comprising the first subset of the resources and the at least first part of the at least one second subset of the resources.

In some example embodiments, second apparatus further comprises: means for transmitting, to the first apparatus, a configuration message comprising a second indication of deactivating at least a second part of the at least one second subset of the resources; and means for receiving, from the first apparatus, a data transmission on a fourth subset of the resources comprising the first subset of the resources and a rest of the at least one second subset of the resources other than the at least the second part.

In some example embodiments, the configuration message comprises one of downlink control information or a medium access control control element.

In some example embodiments, the first apparatus comprises a terminal device, and the second apparatus comprises a network device.

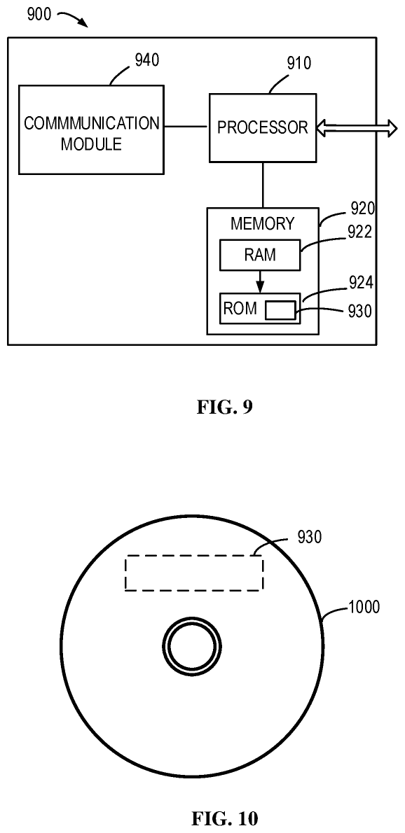

FIG. 9 is a simplified block diagram of a device 900 that is suitable for implementing embodiments of the present disclosure. The device 900 may be provided to implement the communication device, for example the first device 110 or the second device 120 as shown in FIG. 1. As shown, the device 900 includes one or more processors 910, one or more memories 920 coupled to the processor 910, and one or more transmitters and/or receivers (TX/RX) 940 (i.e., the communication module 940) coupled to the processor 910.

The TX/RX 940 is for bidirectional communications. The TX/RX 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 900 may perform any process of the disclosure as discussed with reference to FIG. 2 to FIG. 8. The embodiments of the present disclosure may also be implemented by hardware or by a combination of software and hardware.

In some embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 in form of CD or DVD. The computer readable medium has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700 or 800 as described above with reference to FIG. 7 and FIG. 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-53. (canceled)

54. A first device, comprising:
at least one processor; and
at least one memory storing instructions that, when executed by the at least one processor, cause the first device at least to:
receive, from a second device, first configuration information indicating a set of resources for time-division or frequency-division duplexing communication between the first device and the second device, the set of resources comprising a first subset of the resources for uplink transmission; and
receive, from the second device, second configuration information indicating at least one second subset of the resources for the uplink transmission, the at least one second subset of the resources comprising at least one resource not comprised in the first subset of the resources.

55. The first device of claim 54, wherein the second configuration information comprises:
a starting time resource of the at least one second subset of the resources, and
an end time resource of the at least one second subset of the resources.

56. The first device of claim 54, wherein the second configuration information comprises:
a first resource indicator value indicating a starting frequency resource and a number of frequency resources of the at least one second subset of the resources.

57. The first device of claim 54, the at least one second subset of the resources comprising at least one resource not comprised in the first subset of the resources comprises:
the at least one second subset of the resources is not overlapping with the first subset of the resources.

58. The first device of claim 54, wherein the second configuration information indicates the at least one second subset of the resources in frequency domain, and
wherein the at least one memory storing instructions that, when executed by the at least one processor, further cause the first device to:
receive, from the second device, a configuration message indicating the at least one second subset of the resources in time domain.

59. The first device of claim 58, wherein the second configuration information comprises one of the following:
a starting frequency resource and a bandwidth of an uplink subband corresponding to the at least one second subset of the resources, or
a starting frequency resource and an end frequency resource of an uplink subband corresponding to the second subset of the resources.

60. The first device of claim 58, wherein the first configuration information indicates a time division duplexing pattern for the first device, and the configuration message comprises an indication of at least one slot of the time division duplexing pattern applying the uplink subband.

61. The first device of claim 60, wherein the indication is a bitmap with a number of bits corresponding to a number of at least one of the following:
a plurality of downlink slots or symbols in the time division duplexing pattern, or
at least one special slot or symbol in the time division duplexing pattern, and
wherein a first value of a bit in the bitmap indicates a corresponding slot or symbol applying the uplink subband corresponding to one of the at least one second subset of the resources, and a second value of the bit in the bitmap indicates the corresponding slot or symbol not applying the uplink subband.

62. The first device of claim 60, wherein a plurality of values of the bitmap indicates a plurality of combinations of at least one of the following applying the uplink subband:
a plurality of downlink slots or symbols in the time division duplexing pattern, or
at least one special slot or symbol in the time division duplexing pattern, and
wherein mapping of the plurality of values and the plurality of combinations is preconfigured or predetermined at the first device and the second device.

63. The first device of claim 54, wherein the second configuration information indicates the at least one second subset of the resources in frequency domain, and
wherein the at least one memory storing instructions that, when executed by the at least one processor, further cause the first device to:
receive, from the second device, downlink control information comprising a slot format indicator corresponding to the at least one second subset of the resources in time domain;
determine a third subset of the resources assigned for uplink transmissions based on the slot format indicator, the third subset of the resources comprising the first subset of the resources and the at least one second subset of the resources; and
transmit, to the second device, a data transmission on the third subset of the resources.

64. The first device of claim 54, wherein the first configuration information indicates a first time division duplexing pattern and a second time division duplexing pattern for the first device, and the second configuration information comprises at least one of:
at least one first uplink subband assigned to the first time division duplexing pattern, or
at least one second uplink subband assigned to the second time division duplexing pattern.

65. A second device, comprising:
at least one processor; and
at least one memory storing instructions that, when executed by the at least one processor, cause the second device at least to:
transmit, to a first device, first configuration information indicating a set of resources for time-division or frequency division duplexing communication between the first device and the second device, the set of resources comprising a first subset of the resources for uplink transmission; and
transmit, to the first device, second configuration information indicating at least one second subset of the resources for the uplink transmission, the at least one second subset of the resources comprising at least one resource not comprised in the first subset of the resources.

66. The second device of claim 65, wherein the second configuration information comprises:
a starting time resource of the at least one second subset of the resources, and
an end time resource of the at least one second subset of the resources.

67. The second device of claim 65, wherein the second configuration information comprises:
a first resource indicator value indicating a starting frequency resource and a number of frequency resources in the at least one second subset of the resources.

68. The second device of claim 65, wherein the at least one second subset of the resources comprising at least one resource not comprised in the first subset of the resources comprises:
the at least one second subset of the resources is not overlapping with the first subset of the resources.

69. The second device of claim 65, wherein the second configuration information indicates the at least one second subset of the resources in frequency domain, and
wherein the at least one memory storing instructions that, when executed by the at least one processor, further cause the second device to:
transmit, to the first device, a configuration message indicating the at least one second subset of the resources in time domain.

70. The second device of claim 69, wherein the second configuration information comprises one of the following:
a starting frequency resource and a bandwidth of an uplink subband corresponding to one of the at least one second subset of the resources, or
a starting frequency resource and an end frequency resource of an uplink subband corresponding to the second subset of the resources.

71. The second device of claim 69, wherein the first configuration information indicates a time division duplexing pattern for the first device, and the configuration message comprises an indication of at least one slot of the time division duplexing pattern applying the uplink subband.

72. The second device of claim 66, wherein the second configuration information indicates the at least one second subset of the resources in frequency domain, and
wherein the at least one memory storing instructions that, when executed by the at least one processor, further cause the second device to:
transmit, to the first device, downlink control information comprising a slot format indicator corresponding to the at least one second subset of the resources in time domain; and
receive, from the first device, a data transmission on a third subset of the resources comprising the first subset of the resources and the at least one second subset of the resources.

73. A method comprising:
receiving, at a first device and from a second device, first configuration information indicating a set of resources for time-division or frequency-division duplexing communication between the first device and the second device, the set of resources comprising a first subset of the resources for uplink transmission; and
receiving, from the second device, second configuration information indicating at least one second subset of the resources for the uplink transmission, the at least one second subset of the resources comprising at least one resource not comprised in the first subset of the resources.
